(19) United States
(12) Patent Application Publication
(10) Pub. No.: US 2022/0250063 A1
(43) Pub. Date: Aug. 11, 2022

(54) ASSAY SYSTEM, METHODS, AND MULTI-WELL PLATE FOR GAS STIMULATION OF BIOLOGICAL CELLS, PROTEINS OR MATERIALS

(71) Applicant: Koniku Inc., San Rafael, CA (US)

(72) Inventors: Oshiorenoya E. Agabi, San Rafael, CA (US); Vivek Parthasarathy, San Rafael, CA (US)

(21) Appl. No.: 17/669,251

(22) Filed: Feb. 10, 2022

Related U.S. Application Data
(60) Provisional application No. 63/148,081, filed on Feb. 10, 2021.

(51) Int. Cl. B01L 3/00

(52) U.S. Cl. CPC B01L 3/502715; B01L 2300/0829; B01L 2300/0858; B01L 2300/163; B01L 2300/0681

(57) ABSTRACT

Cells in wells of a microplate may be directly stimulated with gases, vapors or volatile organic compounds in a scalable way while remaining compliant with existing standards. The microplate may be used in designing of GPCR's (G protein-coupled receptors), in biotechnology and synthetic biology, drug development, oxygenation studies, food flavor design and others. An assay system for operating with gas stimulation of cells includes an optical sensor positioned to detect light in the wells.

This application claims priority to U.S. Provisional Patent Application No. 63/148,081 filed Feb. 10, 2021, incorporated herein by reference.

### BACKGROUND

Research and development in pharmaceuticals or biotechnology uses multi-well plates for growing biological cells and monitoring their progress. The cells grown in these multi-well plates can be observed under a microscope, within a robotic system, in fluorescence imagers or similar systems. Generally the cells are stimulated in liquid phase using an automated pipette system or a robotic system. As a result the cells can only be stimulated with liquid and the results can be read in near real time. Examples are flex machines for calcium imaging, regular microscopes or luciferase assay systems which make use of luminometers or a commercially available system such as the Promega Glomax® micro plate reader machine.

While these systems have been widely used in biology and biotechnology, it has been very difficult to stimulate cells with gas in a commercially available system (such as a gas chromatography/mass spectrometry or a proton-transfer-reaction mass spectrometry system) or even in a host of customized systems. Thus, improved designs are needed.

Volatile organic compounds (VOCs) are natural or manmade compounds which readily diffuse into air, due to their volatile characteristics. Many VOCs are toxic to humans and the environment with extended exposure. VOCs are also associated with explosives.

Detecting other types of airborne molecules may be useful for other purposes as well, such as in food and beverage manufacturing, agriculture, diagnosing disease by detecting molecular byproducts in exhaled breath or perspiration, detecting drugs in exhaled breath, and others. Thus, detecting VOCs and other airborne molecules can contribute to human safety and security, better preserve the environment, and assist in healthcare and manufacturing.

A system for detecting airborne molecules (e.g., VOC's) uses living biological cells has been developed as described in U.S. patent application Ser. No. 17/571,363, incorporated herein by reference. The system may use living cells modified to express an odorant receptor. The receptor may be modified to enhance a binding specificity to a particular compound or to alter the receptor from a broadly tuned receptor to a narrowly tuned receptor or vice versa. The system detects the presence of an airborne VOC via a calcium sensitive fluorescent element, voltage sensitive dyes or other reporter that fluoresces, luminesces, or otherwise emits a detectable signal in response to binding of the VOC to the odorant receptor. To increase the number of VOC's that can be detected, and to determine which types of cells, or cell modifications are useful, thousands of VOC's and cells must be assayed. Accordingly, systems and methods for performing these types of assay are needed.

### Overview

Techniques for stimulation of cells, proteins, molecules or any biological sample in gas phase using modified commercially available multi well plates have now been developed. Significantly, the modification of the standard multi well plate does not preclude using the multi well plate in any standard or even customized use case. The dimensions of the commercially available multi well plates may be maintained. However, the underside of the multi well plate is significantly altered to allow the pumping in of gas compounds from a controlled source. This allows the stimulation of cells or biological samples atop a semi permeable membrane to happen in real time while the response from biological materials is read in real time.

Multi well plates used with modified cells expressing odorant receptors allow for rapid assay of thousands of VOCs against thousands of odorant receptors. In addition to use of odorant receptors, any membrane receptor can be attached to the signaling system which allows for the mass assay of possible agonists or antagonists for drug discovery.

### BRIEF DESCRIPTION OF THE DRAWINGS

In the drawings, the same element number indicates the same element in each of the views.

FIG. 1 is a top view of a prior art microplate.

FIG. 2 is a side view and a top view of the microplate of FIG. 1 including representative dimensions.

FIG. 3 is a partial section view of a microplate from the ANSI/SLAS 1-2004 Standard.

FIGS. 4A, 4B, 4C and 4D show alternative designs of the bottom of a microplate.

FIG. 5 is a schematic diagram of a new microplate allowing for gas stimulation.

FIG. 6 is an exploded top perspective view of an alternative embodiment of the microplate of FIG. 5.

FIG. 7A is schematic diagrams of a system for gas stimulation of cells using the microplate of FIG. 5 or 6.

FIG. 7B is a schematic diagram of a system for high throughput screening.

FIG. 8A is a top view of an assay microplate.

FIG. 8B is a bottom view of an alternative assay microplate showing the gas flow channel through or in the microplate.

FIG. 8C is a schematic top view of another alternative assay microplate.

FIG. 9 is a perspective view of an assay system.

FIG. 10 is an exploded perspective view of the assay system of FIG. 9.

FIG. 11 is a perspective view of the assay system of FIG. 9 with covers removed.

FIG. 12 is side view of the assay system as shown in FIG. 11.

FIG. 13 is a perspective view of the optical unit shown in FIGS. 11 and 12.

FIG. 14 is an image as recorded by the system of FIG. 7A, 7B or 9 when benzaldehyde gas was flowing through the assay microplate of FIGS. 8A-8C.

FIG. 15 is an image of the same microplate as in FIG. 14, now with menthol gas flowing through the microplate.

FIG. 16 is an image of the same microplate as in FIGS. 14 and 15, now with 2-pentylfuran gas flowing through microplate.

### DETAILED DESCRIPTION

Microplates, microtiter or multi well plates are rectangular plates utilized in various biological assays including high throughput screening, ELISA (enzyme-linked immunosorbent assay), and PCR (Polymerase chain reaction). Other assays include apoptosis, FRET (Fluorescence resonance energy transfer), Agglutination and Adenylat-Kinase assays and others. Microplates have extensive applications in microscopy, sample collection, compound preparation, combinatorial chemistry, high throughput screening, nucleic acid purification, bacterial culture growth, and plate replication. These plates are ubiquitous in biology and biotechnology. They follow established standards such as ANSI/SLAS (ANSI/SLAS 1-4-2004) (American National Standards Institute) microplate standards, various international and regional certifications concerning use, disposal, and recycling.

Microplates generally have a plurality of wells in a microplate body or unit, with a solid bottom. The solid bottom may be coated with a plurality of compounds, proteins or other materials, and/or have a surface finish which influences cell binding. The coating is usually provided to aid the attachment of biological materials (usually cells) to the bottom of the well. The wells are generally filled with media that promotes the growth or survival of cells. The media may also inhibit the growth of cells under study. A microplate in this way is like any other cell culture dish, plate or flask. However, a multi-well microplate having e. g., 96 wells can be considered as 96 culture plates in parallel.

Standard microplates have 96, 384 or 1536 wells, although microplates having as few as 6, 12, 24 or 48 wells, and as many as 3456 or 9600 wells have been used. The wells are typically arranged in a 2:3 rectangular matrix.

The wells are labelled with numbers and letters to allow for precise addressing of each individual well. Microplates usually come with a cover so that they can be kept in an incubator for example, or maintain sterility. Additionally, the microplates may come in various colors to influence the assay during operation. For example, black microplates are recommended for fluorescence measurements with minimum back-scattered light and background fluorescence, whereas white microplates are recommended for luminescence measurements with maximum reflection and minimal auto-luminescence.

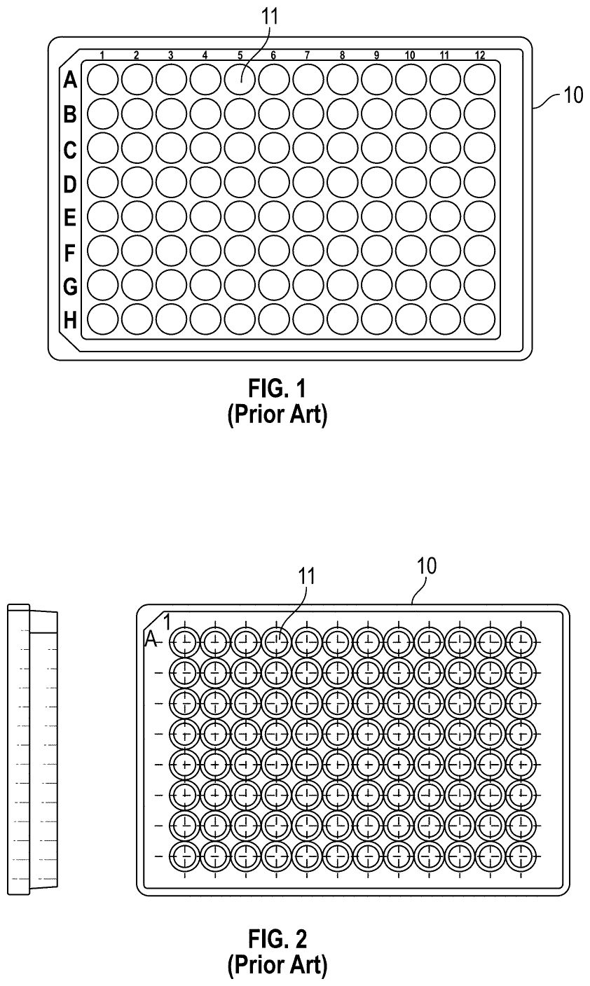

FIG. 1 shows a prior art microplate or microtiter plate 10 having 96 wells 11. Microplates are usually manufactured by injection molding, and may have transparent bottom, generally available with a biocompatible plastic. The left side corners are notched to aid in orienting the microplate 10.

FIG. 2 shows a side view and a top view of a 96 well microplate from ANSI standards ANSI/SBS 1-2004, ANSI/SBS 2-2004, ANSI/SBS 3-2004, and ANSI/SBS 4-2004. The microplate shown 10 is rectangular, about 128 mm long by 85 mm wide.

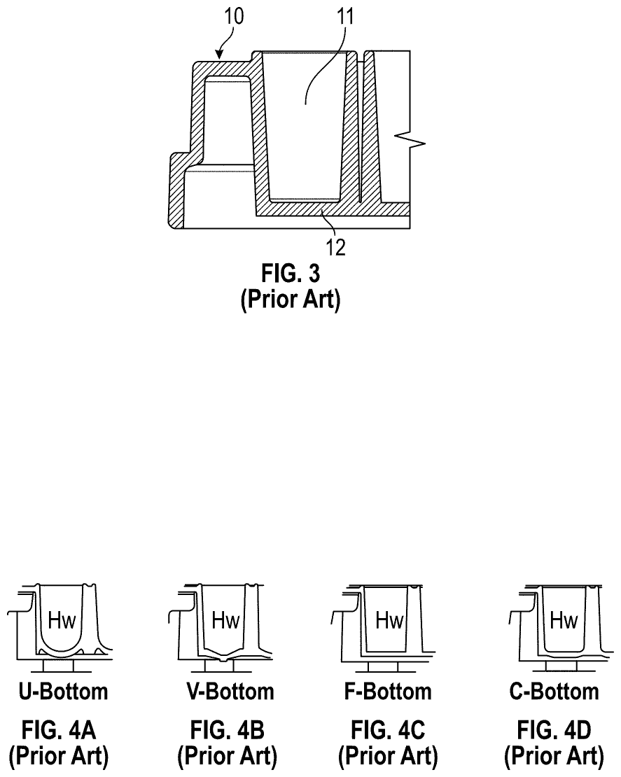

As shown in FIG. 3, usually, the microplate 10 have a solid bottom 12. Thus the bottom of each well 11 is closed off. Referring to FIGS. 4A, 4B, 4C and 4D, the solid bottoms may vary in geometry depending on the application and/or the commercially available automation system used with the microplates. The bottom of the microplate may be replaced by a filter. European Patent EP1007623B1 discloses a permeable membrane which allows the exchange of liquid media between two chambers. Additionally, this design uses an insert.

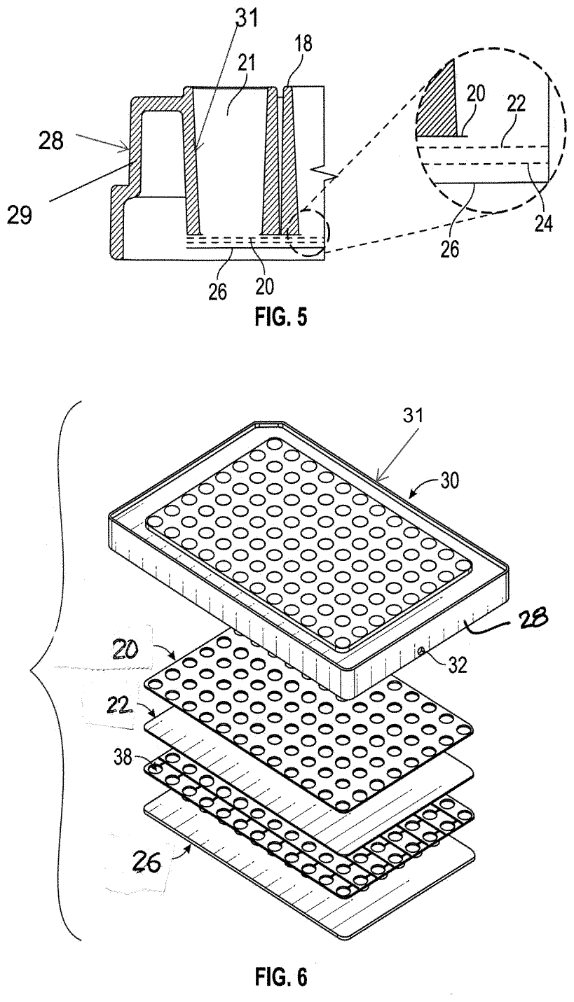

In contrast to the known microplates discussed above, in the present microplate 18 as shown in FIG. 5, the bottom may have additional layers 20, 22, 24 and 26 so that the bottom of the wells 21 is permeable and not closed off as in FIGS. 1-4D. This provides the capability of stimulating cells with gaseous or vapor-based compounds. Yet even with the additional layers, the microplate 18 may be used in the same ways as known microplates, regardless of the number of wells, reading machine, or assay of interest. The microplate 18 is consequently universal in the sense that it can operate with gas or liquid. It does not preclude liquid stimulation or application of liquid to any assay.

As also shown in FIG. 5, the microplate 18 has a perimeter flange 28 having outer sidewalls 29 forming the sides of the microplate 18, and inner sidewalls 31 spaced apart from the outer sidewalls 29. The inner sidewalls 31 form part of the wells 21 at the outside of the array of wells, i.e., the wells in the first and last rows and in the first and last columns of wells. The outer sidewalls project down below the inner sidewalls, and generally also below the bottom layer 26. The size and shape of the perimeter flange 28 preferably conforms to the microplate ANSI standards described above, so that the microplate 18 is compatible with various assay equipment.

The microplate 18 may have the following advantages:

1. Conforms to existing standards for microplates.

2. Maintains the underside clearance such that it is fully compatible with any assay.

3. Adds extra layers to the underside such that gaseous compounds can be pumped into the system with a minimal footprint or burden any secondary system.

4. May add microchannels so that various gases can be piped into the system simultaneously with delay or fine control of the timing.

5. May operate with an external system of control which communicates with any secondary system such that secondary system knows when to log data.

6. The addition of an external system may allow control of a sublimation process, vaporization or the elution liquids, or complex flavors in liquid format directly into the present multi-well plate. The present design also allows the direction measurement piping of gases from headspaces from solids, liquids or gas directly into a biological chamber for real time measurements.

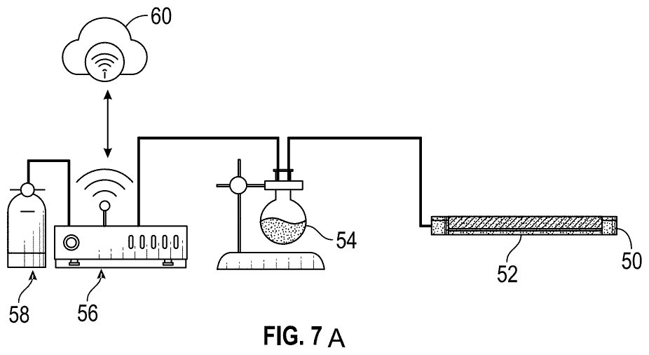

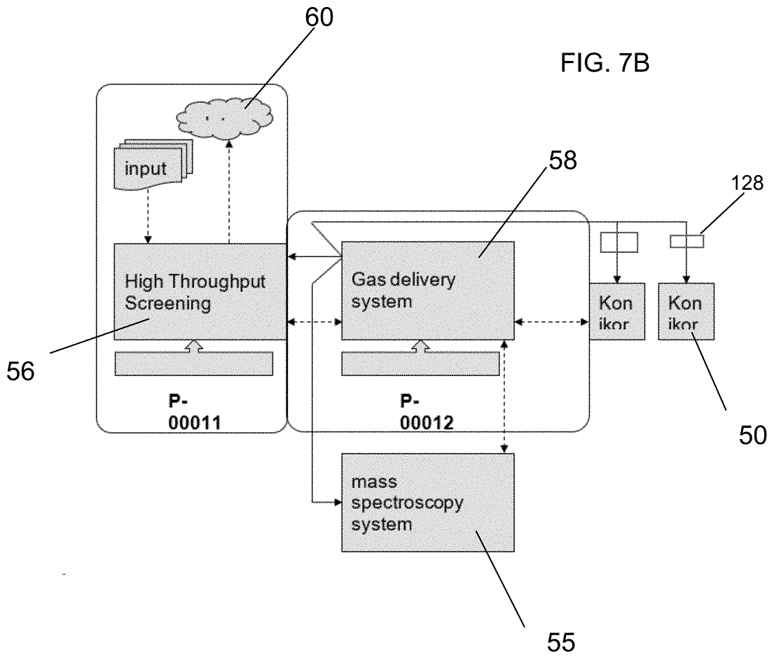

7. The system of FIG. 7 allows data to be streamed directly into the cloud.

In the microplate 18 the transparent bottom of a standard micro plate may be replaced by four layers namely:

a. An adhesive layer. Referring to FIG. 5 an adhesive layer 20 allows the attachment of a semi-permeable membrane 22. The adhesive layer may also be attached using a biocompatible silicone grease or any biocompatible substance promoting the adhesion of the semi permeable membrane 22.

b. A semi permeable layer. The semi permeable membrane 22 can support the growth of cells after treatment with PDL (pulse dye laser) for example. Other treatment methods may include fibronectin, collagen or laminin treatment to promote neural proliferation on the membrane. The membrane 22 is semi-permeable meaning it permits the exchange of gas but not liquid. The membrane 22 can also be a transparent solid material with pores. The pores make a membrane semi-permeable. Therefore, the cells can directly interact with gas particles without losing the 100% humidity they are immersed in.

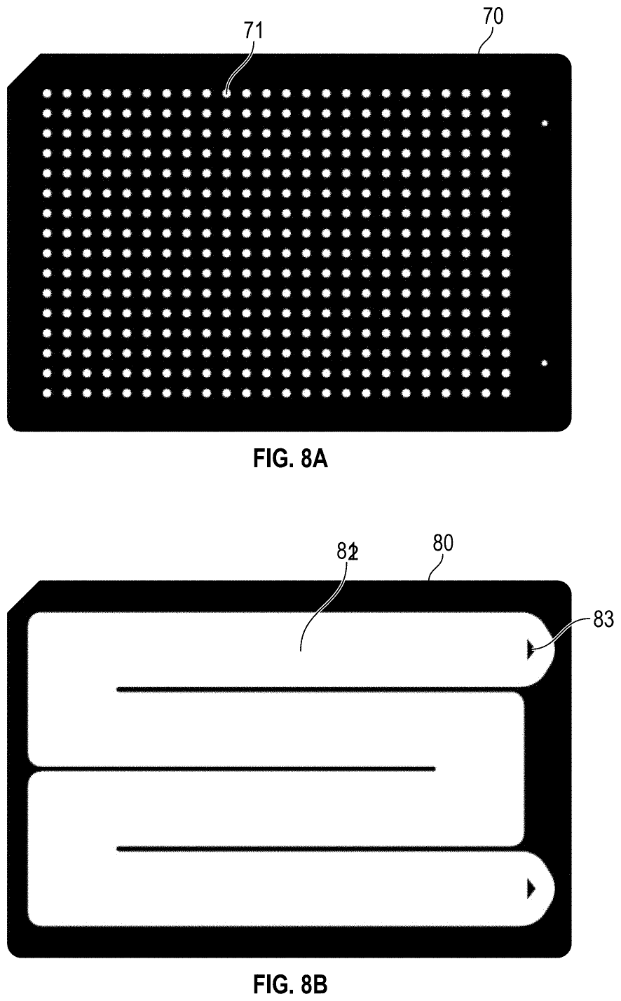

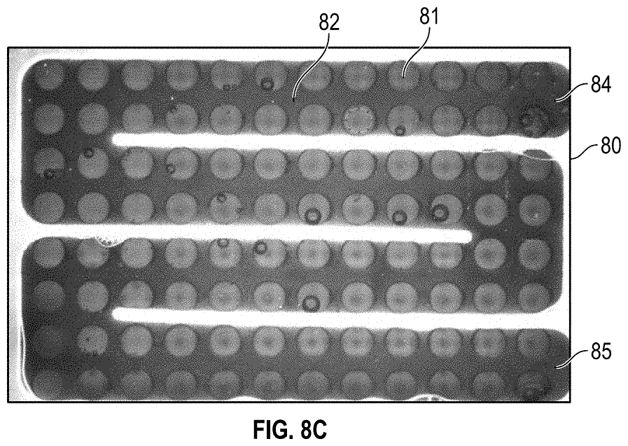

c. A perfusion layer 24 has a fluid channel 82 (in FIGS. 8B and 8C), or with the bottom layer 26 forms a fluid channel 82. The fluid channel conducts a the flow of gas to individual wells. The perfusion layer 24 may allow only a single gas, meaning the adhesive layer 20 only serves to secure the attachment of the bottom layer 26 and the layer 24 in FIG. 5. In this instance, it makes the space between the membrane or layer 22 and 26 a free space for gas to diffuse naturally. Layer 24 may also contain a system of channels, valves and sensors and even processing electronics to measure other characteristics of the gases being measured. Also, layer 24 supports a conduit (Luer-lock compatible orifice) for an external gas supply line which may come from external sources. Liquid may alternatively be flowed through the fluid channel 82 for liquid stimulation instead of gas stimulation. In this case, the membrane 22r is selected to be liquid permeable.

d. The bottom layer 26 is an optically transparent layer which permits unrestricted access for imaging via a CMOS sensor, PMT's, photodiode arrays or other sensor types. The bottom layer is also non permeable to water vapor or gas. The bottom layer may be a uniform transparent layer of glass, plastic, acrylic, polystyrene, etc.

Layers 20, 22, 24 and 26 are generally sealed to prevent the loss of gas and escape of water vapor or other biological materials outside of what is standard with a microplate. In some embodiments, layer functions may be combined and the micro plate may have less than four layers. For example, if the semi-permeable layer 22 is attached to the bottom surface of the microplate using alternative techniques, then the adhesive layer 20 may be omitted. Similarly, if the optically transparent layer 26 is spaced apart from the semi-permeable layer 22 to create a gas or fluid space between them, then a (physical) perfusion layer 24 may be omitted.

The layers may be laser cut from polyethylene terephthalate plastic sheets (PET) or other materials, such as silicon, fused-silica, glass, any of a variety of polymers, e.g., polydimethylsiloxane (PDMS; elastomer), polymethylmethacrylate (PMMA), polycarbonate (PC), polypropylene (PP), polyethylene (PE), high density polyethylene (HDPE), polyimide, cyclic olefin polymers (COP), cyclic olefin copolymers (COC), epoxy resins, metals (e.g., aluminum, stainless steel, copper, nickel, chromium, and titanium), or any combination of these materials. The layers may be attached and sealed together via an adhesive, solvent welding, clamping or by using bio-compatible double sided tape and a hot press. The layers may optionally be made of glass and/or PDMS (silicon-based organic polymer) assembled using plasma bonding.

FIG. 6 shows a design using a standard 96 well microplate 30 with the bottom removed leaving a microplate body 31. Luer lock compatible holes or custom holes 32 are provided through the flange 28 of the microplate body 31 to connect gas inlet and outlet tubes of the gas delivery system to the gas channel 82 in the microplate. Multiple gas inlets and gas outlet holes may be used. An adhesive layer 20 is used to attach a semi-permeable membrane 22 to the bottom of the microplate body 31. The adhesive layer 20, which may also be silicon paste or grease, also prevents loss of moisture from the wells. The semi-permeable membrane 22 may be a membrane or a transparent rigid layer with pores.

The membrane 22 on which the cells are living provides the interface that separates the controlled cellular environment from the outside air. The membrane may advantageously allow VOCs (or other candidate molecules or compounds) to diffuse across the membrane in seconds; prevent bio-contaminants from entering the cell medium and damaging the cells; be optically transparent in order to visualize the cells; be chemically compatible with cell adhesion and growth; and be mechanically, chemically and heat resistant. The membrane may be a thin (15 microns) PTFE (Teflon® fluorine resins) membrane with high porosity (75%) and a maximum pore size of 30 nm, which is smaller than bacteria and most relevant viruses. The membrane may be opaque when dry, however after wetting of the membrane with a low surface tension fluid like isopropyl alcohol, the membrane becomes transparent and can be kept transparent as long as one side is kept in contact with IPA, water, or cell medium. In spite of its thinness, the membrane is sturdy and can be heated to more than 200 degrees Celsius, which allows coating it with an anti-stiction material on the external side for some applications while improving cell adhesion by treating it with plasma, and incubating it with poly-D-lysine on the inward-facing side. A silicon oxide (SiO2) membrane may also be used.

A second adhesive layer 38 may support or include a micro fluidic framework, valves, controllers or electronic sensors. The layer 38 may be self-adhesive. Additional chemical modification may be applied to prevent the adhesion of specific gas molecules or intentional fouling. The optically transparent bottom layer 26 or a coverslip prevents gas escape but allows optical inspection. This design has at least four layers. All layers are hermitically sealed allowing the perfusion of gas from an external source. The designs shown comply with applicable ANSI/SLAS standards. For example, the dimensions of the microplate shown in FIG. 6 may be 127.70 mm×85.50 mm×12.45 mm.

Turning to FIG. 7A, an aerosol or gasified sample is provided by the gas delivery system 54 using a heater, coil heater, ultrasonic element, piezo element, etc. for movement into the microplate 50. An assay or screening machine 56 has a computer controller which sends data to the cloud 60, appends timestamps to data from external reader 52, controls the injection of a gas into the sample from a gas tank or gas delivery system 58, to carry the sample through the microplate, as well as controlling generation of the sample and monitoring the read out from a microplate 50. Alternatively, the gas may injected to move the sample as a slug through the microplate, without deliberate mixing of the sample and the gas. The gas is a carrier gas, and may be inert. The microplate 50 contains cells. The response is modulated by the sample. Data is sent to a database containing timestamps from the injection of gas, and sensor readings from the channel layer and other relevant parameters.

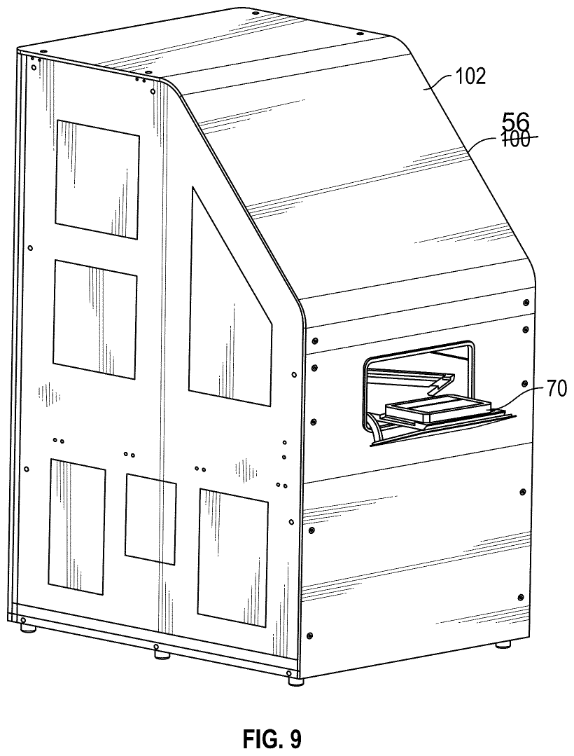

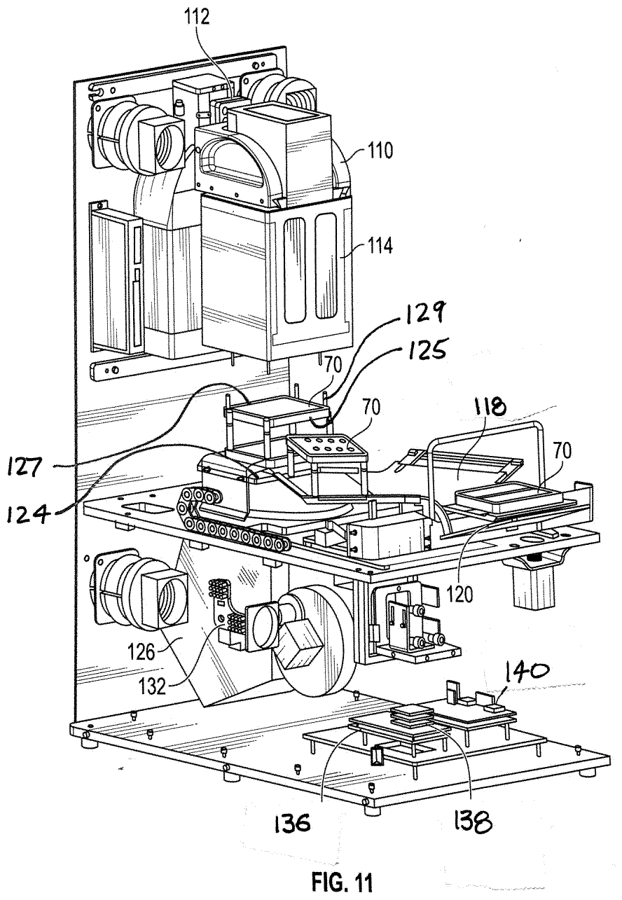

FIG. 7B shows a similar system adapted for high throughput screening. This system may run multiple, e.g., four, high throughput screening machines 56, of the type shown in FIGS. 9-12, in parallel. With this configuration, the gas delivery system 58 is connected to each of the machines 56, allowing multiple microplates may be assayed simultaneously. The screening machines 56 receive input instructions from the cloud, other memory, or a user interface. The gas delivery system 58 may include its own user interface and computer with a stored library of all compounds that are introduced into the assay system of FIG. 7B. A mass spectroscopy system 55 may be associated with the gas delivery system 58 for parallel analysis of the VOC delivered. In this case, each time the gas delivery system 58 delivers a VOC sample to one of the connected machines 56, it also delivers the equivalent amount to the spectroscopy system 55 for comparison analysis. The spectroscopy system 55 identifies the gas delivered and its concentration.

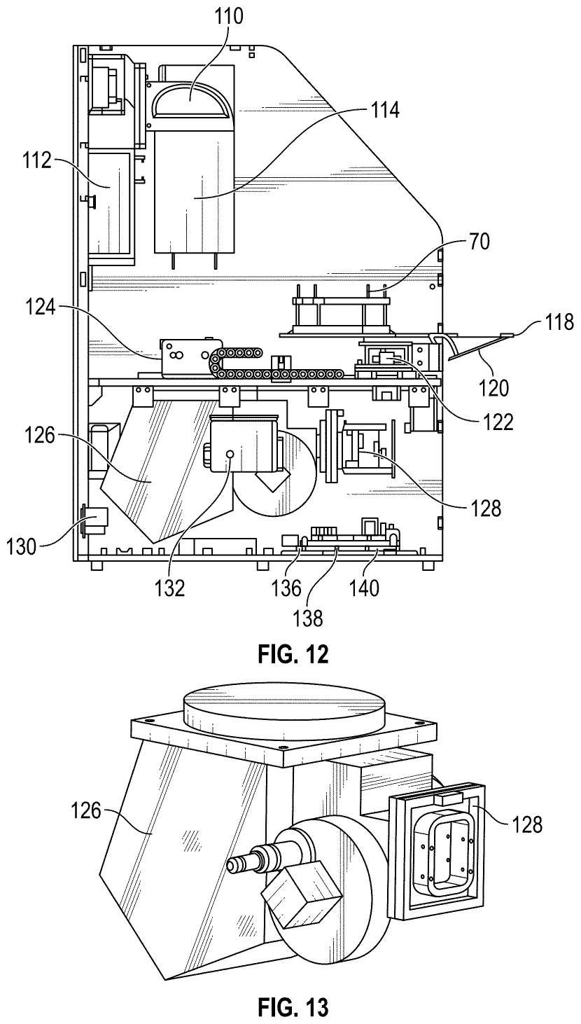

The screening machine 56 controls the gas delivery system, stores all results, including from the mass spectroscopy system 55, and all sampled data, images and video clips, which may be sent to cloud storage 60 or to a hard drive. It may also preprocess data, images and video. The screening machine 56, or an auxiliary controller, may also display of information about the testing, including identity of the cells, assay format, identity of the VOCs, number of runs, dates and scheduling, instructions, allocation of assay plate and serial number, as well as bar code scan data, generate and send reporting email, text or web-based messages. The gas delivery system 58 may supply multiple microplates with multiple gas samples, have its own computing abilities and user interface. It may also have an internal library of all compounds that are loaded to the device. In FIGS. 7A and 7B a camera such as the camera 128 shown in FIG. 12, is positioned to detect light from the wells, and is also electrically connected to the screening machine 56. Alternatively, microwires may project into the wells to detect and record field potentials from the cells as reactions, instead of using the camera 128 or other optical device.

FIGS. 8A-13 show microplates and a system for rapid assay. In some embodiments, candidate molecules or compounds can be detected or screened using any target membrane receptor (e.g., receptors targeted for drug discovery) coupled to a reporter. As described in U.S. patent application Ser. No. 17/571,363, airborne VOC's can be detected via modified cells with an odorant receptor coupled to a reporter, e.g., a fluorescent reporter or a luminescent reporter according to some embodiments. In other embodiments, the target membrane receptor may be a receptor that has been identified as involved in a pathogenic process, condition, or disease and/or is otherwise identified as a target for drug discovery. Suitable cells that may be used in certain embodiments described herein are discussed below. Cells expressing odorant receptors or other target membrane receptors, e.g., those disclosed below, are placed in the wells of a microplate. The VOCs or other candidate molecules or compounds may be carried into and through a microplate via a pumped or aspirated flow of an inert gas, such as helium, neon, argon, krypton or xenon, with or without including air or nitrogen. Cells that emit a signal, e.g., by fluorescing or luminescing when exposed to a specific VOC or other candidate molecule or compound are identified and characterized. This allows for rapid testing of large numbers of cells and VOCs or other candidate molecules or compounds, large numbers of candidate molecules or compounds that could bind one or more target membrane receptors, and also allows for a high degree of automated operations.

In some embodiments, collection and analysis of cell and VOC specific data allows for creation of a database providing guidance on how to modify cells genetically for use as VOC detectors, rather than relying only on native cells. The data may be used to create new cells expressing odorant receptors that bind better to specific VOCs. Such new cells may then be used to improve airborne detection systems, such as the system described in U.S. patent application Ser. No. 17/571,363. In some embodiments, the data may be used to design and/or reengineer ORs for enhanced binding by VOCs using suitable in silico or 3D protein programs known in the art, or through additional analysis in cloud systems like those discussed herein.

In other embodiments, collection and analysis of cell and drug candidate specific data allows for creation of a database of potential therapeutic molecules and provides guidance on how a potential therapeutic molecule or compound can be modified to better bind a target receptor. Such embodiments can lead to the development of more effective therapeutic agents.

Different VOCs or other candidate molecules or compounds may be sequentially pumped or aspirated through the microplate, separated by a volume of air or gas. The microplates loaded with cells for testing may be reused because the stimulation of the cells by the VOCs or other candidate molecules or compounds does not kill the cells. Some cells may require a recovery time interval or refractory period between being sequentially exposed to VOCs or other candidate molecules or compounds. In this case the supply of VOCs or other candidate molecules or compounds to the microplate may be timed to provide a desired recovery time interval.

FIG. 8A shows a microplate 70 having a 16×24 array of wells totaling 384 wells 71. Of course, microplates may be provided having larger numbers of wells, even thousands of wells. The dimensions of the microplate may be larger, or the wells made smaller, or both, for this purpose.

FIG. 8B shows a microplate 80 having a gas channel of four parallel segments and an 8×12 array of wells 81 totaling 96 wells. As shown in FIG. 8C, a single continuous gas flow channel 82 extends under each of the wells 81. The width of the gas flow channel 82 may intersect two rows of wells 81, and have a double U-shape.

Alternatively, if the gas channel 82 shown in FIG. 8B is used with the 384 well pate of FIG. 8A, the gas channel 42 will intersect four rows of wells. Other well plate formats (e.g., 1536, 3456, 9600 wells) may be used with the gas channel 82 of FIG. 8B to increase the number of wells intersecting the gas channel 82. Similarly, smaller well plate formats (48 wells) may have a single row of wells intersected by the channel 82. Other configurations may also be used, including providing multiple gas flow channels in or on the microplate 80. As shown in FIG. 8B, flow elements 83 may be provided in the gas flow channel to direct gas flow and/or to create turbulence. An inlet 84 and an outlet 85 provide connection points or fittings for gas moving into and out of the gas flow channel 82. The cells are on a gas-permeable element, such as a membrane, at the bottom of the wells 81. The membrane separates the wells from the gas flow channel 82, while allowing VOC molecules or other candidate molecules or compounds in the gas flow to diffuse through the membrane and contact the cells.

Alternatives to the channel shown in FIG. 8B may be used, such as a channel as a single channel for a row of wells, or two or more rows, etc., or channels running parallel to the width or shorter dimension of the microwell plate. The channel of FIG. 8B works well for delivering the aerosol to all the wells simultaneously in real time or approximately simultaneously in real-time. In alternative embodiments, separate channels may direct gas flow to individual wells or to a smaller subset of wells. Separate channels may be used to deliver different gas or aerosol samples to the same microwell plate to screen multiple samples at the same time.

The system of FIGS. 9-13 may also be adapted for operation using a liquid for transporting the VOCs or other candidate molecules or compounds, for example by pumping a VOC or other candidate molecule or compound laden liquid through the microplate instead of a gas or vapor.

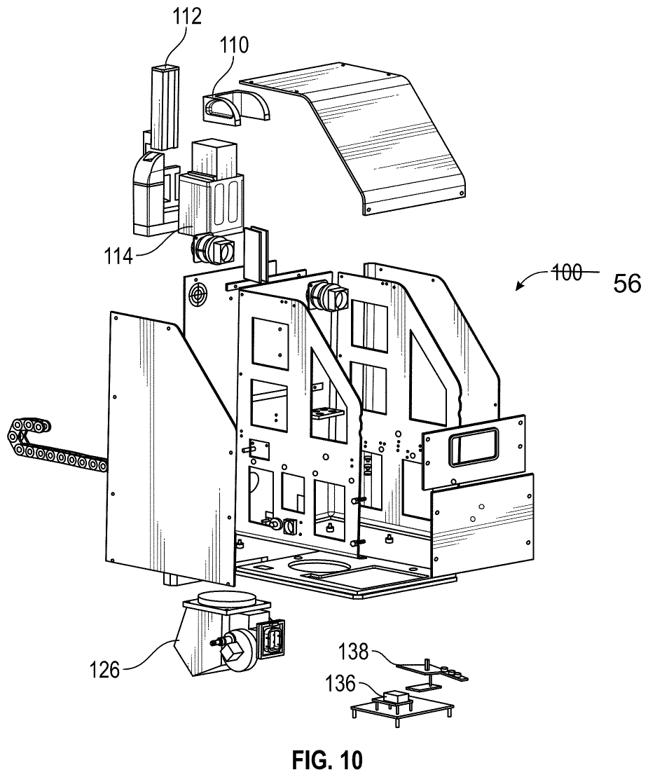

As shown in FIGS. 9-12, in one embodiment a rapid and automated high throughput screening machine 56 has a front opening in a housing 102 for loading and unloading microplates, such as microplate 70. Referring to FIGS. 10-12, the machine 56 may have a pipetting head 114 on a pipetting head holder 110 supported on a linear actuator 112. The pipetting head 114, if used, has an array of pipettes 116 matching the array of wells in the microplate. The pipettes are supplied with liquid containing cells which the pipettes deposit into the wells. The cells settle onto the membrane at bottom of the wells. Each pipette may be supplied with the same liquid. Alternatively, pipettes may be provided with different liquid and cells from multiple supply lines connected to the pipettes. The housing 102 may provide a dark enclosure to avoid interference from stray light or reflections.

Alternatively, cells may be deposited into the wells before the microplates are moved into an automated assay system, with the microplate optionally having a sealed top surface isolating the wells from the environment, using a film, foil, or a standard microplate cover. In this case, the pipetting head 114, pipetting head holder 110 and the linear actuator 112 may all be omitted.

A disk support 124 is aligned under the pipetting head 114. A support frame 125 has a gasket 127 to provide a gas-tight seal with the gas inlet and the gas outlet of a microplate 70 docked on or in the support frame 125. Clamping posts or actuators 129 may clamp the microplate down onto the gasket 127. Gas inlet and outlet lines connect from gas delivery system to the support frame 125 and to the gas inlet and outlet of the microplate. An optical unit 126 contains light sources, lenses and light guides arranged to conduct fluorescent light from cells in the wells to a camera 128. The camera may be a CMOS detector, CCD camera or others. In some applications, and if the reporter is a luminescent reporter, the camera and related optical elements may be omitted and replaced only by an optical sensor.

The camera 128, a circuit board 136, a computer 138 (e.g., a Jetson Nano computer) and an electronic controller 140 (e.g., an Arduino controller) are electrically connected. A hatch 120 on the front of the housing 102 may be opened manually or automatically to insert and remove microplates onto or from a disk 118. A drawer 122 moves microplates onto and off of a disk 118. The disk 118 rotates to sequentially move microplates onto the disk support 124. A servo motor 132 moves components of the machine 56 within the housing 102. Connectors and liquid and gas fittings 130 on the housing connect to external power supplies and liquid and gas sources.

In a representative example of operation, an empty microplate is placed in the hatch 120 by a technician or automatically using a microplate loader/unloader. The microplate is moved to the disk support, with the wells aligned with the pipettes. The pipetting head holding the pipettes is lowered to position the tips of the pipettes in or near the wells. The pipettes deposit liquid containing cells into the wells. Inlet and outlet gas nozzles or fittings engage the gas channel inlet and outlet in the microplate. In some embodiments, there are more than one inlets and outlets that correspond to the number of channels and number of samples injected. Gas containing a VOC or other candidate molecule or compound sample is injected through the gas channel of the microplate. This may be done manually or via automation.

If the VOC or other candidate molecule or compound in the sample binds and activates the odorant receptor expressed by the cells, a signal is emitted (e.g., emission of fluorescent or luminescent light). The signal is detected by the camera 128 via the optical unit 126. The computer 138 analyzes and records the location (i.e., the well number or position), the intensity, time duration, color, and/or other parameters of the fluorescent light, along with data on the VOC or other candidate molecule or compound momentarily passing through the microplate. The computer 138 may calculate the mean of the pixels for each well in each of the images.

After testing, the inlet and gas flow channel in the microplate may be purged with inert gas. Another and different VOC or other candidate molecule or compound can then be moved through the microplate. Thus, each microplate may be used to test cells with multiple VOC's or other candidate molecules or compounds. When all testing is completed, the microplate is moved back to the hatch 120 for removal from the system. A fresh microplate may be simultaneously moved into position on the disk support 124, and the process repeated.

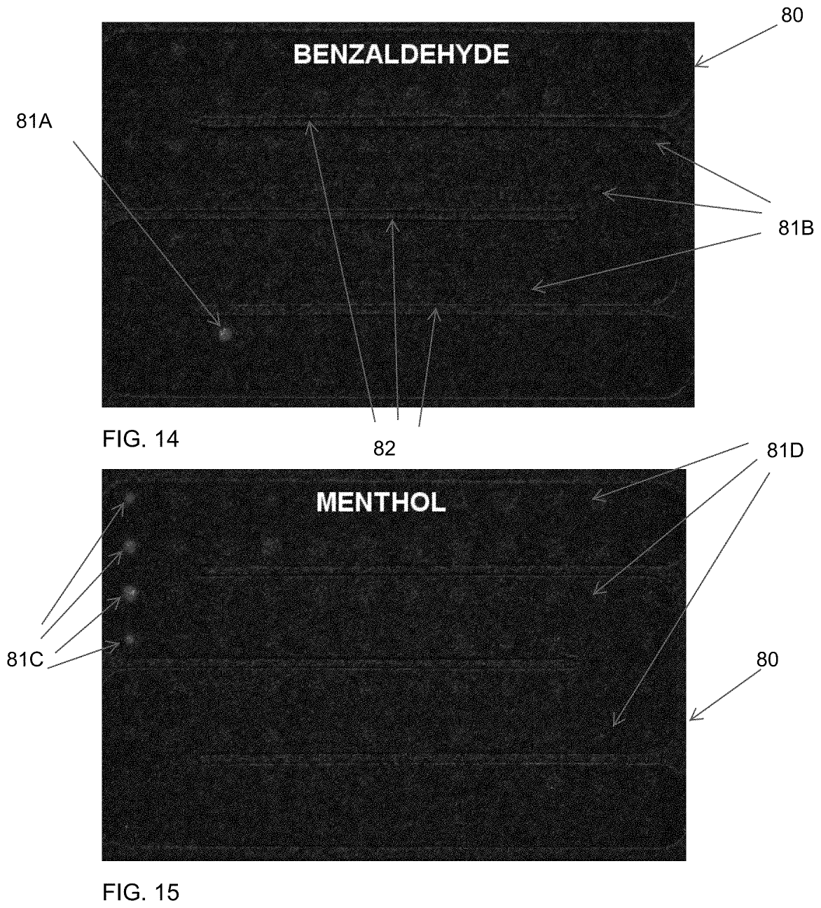

FIG. 14 is an image as recorded by the camera 128 with a sample of benzaldehyde provided into the gas channel of a 96 well microplate 80. As shown, one well 81A is strongly fluorescing (appearing as a brighter spot) while all of the other wells 81B are not at all. This result indicates that the odorant receptor of the modified cells in the well 81A are binding to the benzaldehyde, and can used to detect benzaldehyde.

FIG. 15 is an image as recorded by the camera with a sample of menthol in the gas channel in the same 96 well microplate 80 shown in FIG. 14. Four wells 81C in the first column show a strong fluorescent responses. All of the other wells 81D show no fluorescent response and are entirely dark. This result indicates that the odorant receptor of the modified cells in the wells 81D are not binding to the menthol.

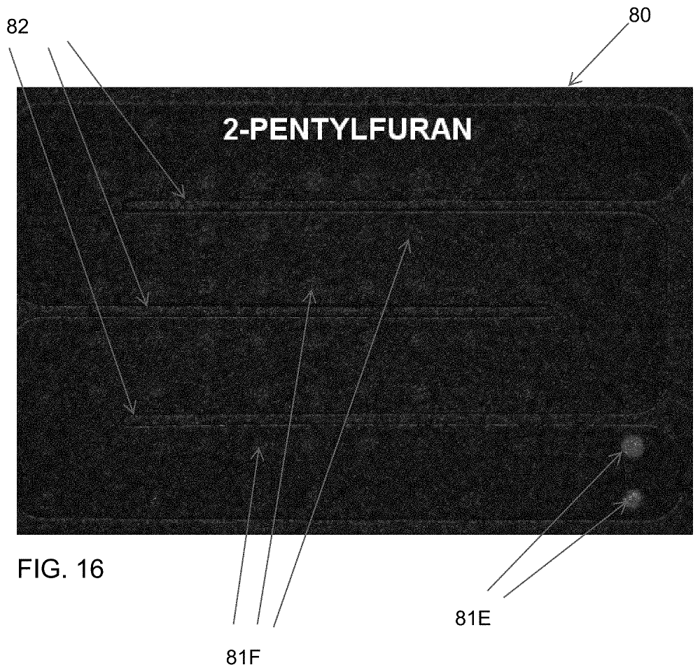

FIG. 16 is an image as recorded by the camera with a sample of 2-pentylfuran in the gas channel in the same 96 well microplate 80 shown in FIG. 14. Two wells 81E in the at the lower right show a strong fluorescent responses. All of the other wells 81F show no fluorescent response and are entirely dark. This result indicates that the odorant receptor of the modified cells in the wells 81F are not binding to the 2-pentylfuran. In FIGS. 14, 15 and 16, the arrows from 81B, 81D and 81F are representative of all of the 95 dark wells in FIG. 14, the 92 dark wells in FIG. 15, and the 94 dark wells in FIG. 16.

The microplate 80 shown in FIGS. 14-16 has different cells in different wells. As shown, the odorant receptors of different cells bind to different compounds. In each well of the 96 well microplate 80, the cells expressed the same OR. Different ORs were provided into different wells. Thus, for example, in FIG. 15, the four wells strongly fluorescing in response to menthol each had different ORs that could detect menthol with differing signals. This allows determination of which ORs may best detect menthol. It may also allow for genetically fine tuning the receptors.

By detecting fluorescent light in the wells, the system can determine how each VOC or other gas sample activates different populations of cells using a microplate having wells containing different types of cells

The microplate 18 material or layers may be black, or coated or stained with a black surface finish, except for the areas that extend across the wells. This may reduce stray light or reflections while still allowing the camera to detect light from the cells.

While the embodiments discussed herein are directed primarily to detection of VOCs and identification or screening of odorant receptors, the assays, systems, and methods described herein represent a platform that may also be used to detect or screen other aerosolized molecules or compounds that bind target membrane receptors, e.g., for drug discovery, compounds emitted from foods and beverages, molecular byproducts in exhaled breath or perspiration, or any other suitable purpose. Non-limiting examples of cells and methods that may be used by the platform are discussed below.

Genetically Engineered Cells for Use in Assay Systems and Methods

In accordance with certain embodiments, a population of genetically engineered cells may be placed in or added to the wells of a microplate for use in the methods, systems, or assays described herein. In some embodiments, the genetically engineered cells are generated from heterologous host cells that are transfected with one or more genes, at least partially from olfactory neurons. In some embodiments, the host cell or cells may be of any wild type or engineered cell type that are capable of expressing an olfactory or odorant receptor (OR). The cells may be genetically modified to express the set of accessory proteins to facilitate expression of the OR and visualization of its activation; and/or to express factors that increase cell durability, ability to divide and proliferate, or other characteristics to enhance survival when used in the system described herein. Suitable cells or cell lines that may be used as a host cell include, but are not limited to, neuronal or glial cells and derivatives thereof (e.g., olfactory neurons, astrocytes, CAD cells, ReNCells and others), embryonic cells and derivatives thereof (e.g., HEK293T cells, HANA3A cells), endothelial cells and derivatives thereof (e.g., A549 cells), or stem cells. In certain embodiments, the host cell is a HEK293T cell, HANA3A cell, primary astrocyte, or an A549 cell. It is noted that while olfactory neurons may be suitable, they are challenging to obtain; they can only be extracted from primary tissues as they cannot divide in vitro, and relatively few neurons are present in each brain, which increases the production costs and raises ethical concerns. Furthermore, it has been shown that in vivo, olfactory neurons have a limited lifespan of one to three months.

Cell signaling pathway molecules. In some embodiments, an engineered cell is designed to express a set of cell signaling pathway molecules to facilitate the expression and activation of a target membrane receptor. In certain embodiments, the engineered cell is designed to express sufficient signaling molecules to activate the calcium signaling pathway including, but not limited to, one or more of: a suitable G protein or portion thereof that is activated upon a candidate molecule's binding of a target G protein coupled membrane receptor (i.e., the target membrane receptor) and subsequent activation of the phospholipase C (PLC) pathway to release intracellular calcium, and suitable accessory proteins to facilitate expression of the target membrane receptor.

Olfactory signaling pathway molecules. In some embodiments, an engineered cell is designed to express a set of cell signaling pathway molecules to facilitate the expression and activation of an olfactory (or odorant) receptor. In some embodiments, an engineered cell is designed to express a set of olfactory signaling pathway molecules that facilitate expression of an olfactory receptor including, but not limited to, (i) a synthetic olfactory G protein alpha subunit (G_{αolf}) capable of activating phospholipase C (PLC) when the olfactory receptor is activated, (ii) at least one receptor expression-enhancing protein (REEP) gene, (iii) at least one receptor transporting protein (RTP) gene, and (iv) a resistance to inhibitors of cholinesterase 8B protein (Ric8b) gene. To design the engineered cells described herein, a heterologous host cell may be transfected with a set of one or more olfactory signaling pathway genes according to the embodiments described herein.

According to the embodiments described herein, the term “gene” refers to a DNA molecule that includes a nucleotide sequence that, when expressed, produces an RNA molecule, (e.g., mRNA, tRNA, rRNA, miRNA, siRNA, shRNA, cRNA, ncRNA, IncRNA, snoRNA, snRNA, piRNA), a peptide, a polypeptide, a protein, or functional fragments thereof (e.g., a domain, motif, portion, or fragment of a parent or reference compound that retains at least some activity associated with that domain, motif, portion, or fragment of that parent or reference compound). A gene may be genomic DNA, a cDNA molecule, a synthetic DNA molecule, or a portion thereof—all of which may be either single or double stranded. The polypeptide, RNA molecule, peptide, polypeptide, protein, or functional fragment thereof can be encoded by a full-length coding sequence of the gene, or by a portion of the coding sequence provided the desired activity or functional properties of the full-length or fragment are retained. The DNA sequence may include one or more coding portions (exons), one or more intervening non-coding portions (introns), or a mixture of coding and non-coding portions. In certain aspects, a gene may be a recombinant DNA sequence that is synthesized or otherwise produced in accordance with methods known in the art to design and express a desired RNA, peptide, polypeptide, protein, or a functional fragment thereof. The gene may be a wild type nucleotide sequence, or it may be a mutant, variant, or otherwise modified nucleotide sequence.

The set of one or more olfactory signaling pathway genes is determined based on the type of heterologous host cell used to generate the genetically engineered cell. In some aspects, the host cell does not natively possess the machinery necessary to detect VOCs or other candidate molecule or compound, e.g., the set of olfactory signaling pathway genes. Thus, to detect VOC or other candidate molecule or compound, the host cell or cells may need to be “patched” with one or more additional genes, including OR transporter proteins and chaperones that help with proper expression, proteins involved in the signal transduction, and a calcium indicator. On the other hand, some cells may endogenously express one or more genes of the set of olfactory signaling pathway genes, so the number of genes the cell is transfected with is fewer than a cell that does not express any of the desired genes endogenously.

The one or more olfactory signaling pathway genes that may be part of the set used in a accordance with some embodiments include one or more of (i) an olfactory G protein alpha subunit (G_{αolf}) gene (or portion thereof) that, when expressed, can bind the olfactory receptor and is capable of activating phospholipase C (PLC) when the olfactory receptor is activated, (ii) at least one receptor expression-enhancing protein (REEP) gene, (iii) at least one receptor transporting protein (RTP) gene, and (iv) a resistance to inhibitors of cholinesterase 8B protein (Ric8b) gene.

The one or more olfactory signaling pathway genes that may be part of the set of genes used in accordance with the embodiments described herein include an olfactory G protein alpha subunit (G_{αolf}) gene or a portion thereof. The olfactory G protein alpha subunit gene (G_{αolf}) may be any gene that encodes an alpha subunit of the olfactory receptor-binding G protein, Golf, or a portion thereof. See, e.g., Belluscio, L. et al. (1998) Neuron 20: 69-81; Jones, D. T. and Reed, R. R. (1989) Science 244: 790-795, which is incorporated by reference as if fully set forth herein. Odorants induce responses in olfactory sensory neurons via an adenylate cyclase cascade mediated by a G protein. An olfactory-specific guanosine triphosphate (GTP)-binding protein alpha subunit has been characterized and suggests that said G protein (G_{αolf}) mediates olfaction. In certain embodiments, the G_{αolf} gene is a chimeric G protein, including a portion of G_{αolf} and a portion of another G protein subunit. In some embodiments, the chimeric gene is a G15 chimera (also known as G15olf47) in which the last 57 amino acids of Gα15 were replaced by the last 47 amino acids of G_{αolf}.

The one or more olfactory signaling pathway genes that may be part of the set of genes used in accordance with the embodiments described herein include at least one receptor expression-enhancing protein (REEP) gene. In certain embodiments, one or more olfactory signaling pathway genes that may be part of the set includes two or more REEP genes. REEP family members were originally discovered and described in terms of their ability to enhance plasma membrane or functional expression of G protein coupled receptors (GPCRs), e.g., ORs and bitter or sweet taste receptors. According to the embodiments described herein, “REEF)” refers to a REEF nucleotide sequence encoding a REEF peptide, protein or functional fragment thereof. The term REEF includes wild-type REEF proteins (e.g., REEP1, REEP2, REEP3, REEP4, REEP5, and REEP6) as well as those that are derived from wild-type REEF (e.g. variants of REEF polypeptides). In certain embodiments, the one or more olfactory signaling pathway genes that may be part of the set includes two or more REEF genes and those two or more include REEP1 and REEP2.

The one or more olfactory signaling pathway genes that may be part of the set of genes used in accordance with the embodiments described herein include at least one receptor transporting protein (RTP) gene. RTP genes encode accessory proteins to mammalian odorant receptors (ORs) and are expressed in olfactory sensory neurons to facilitate OR trafficking to the cell-surface membrane and ligand-induced responses in heterologous cells. According to some of the embodiments described herein, “RTP” refers to an RTP nucleotide sequence encoding an RTP peptide, protein or functional fragment thereof. The term RTP includes wild-type RTPs (e.g., RTP1, RTP2, RTP3, and RTP4) and those that are derived from wild-type RTP, e.g., variants of RTP proteins or peptides including but not limited to RTP1-A, RTP1-B, RTP1-C, RTP1-D, RTP1-E, RTP1-A1, RTP1s, RTP1-D1, RTP-D2, RTP-D3, or chimeric genes constructed with portions of RTP1 coding regions (e.g., RTP1-A1-A (Chimera 1), RTP1-A1-D2 (Chimera 2), RTP1-A1-D1 (Chimera 3), RTP4-A1-A (Chimera 4), RTP4-A1-D2 (Chimera 5), and RTP4-A1-D1 (Chimera 6). In certain embodiments, the RTP gene is an RTP1s gene.

Reporters and detection of receptor activation. The set of genes described above provides a signaling pathway that leads to an intracellular release of calcium via activation of phospholipase C (PLC). An increase in intracellular calcium caused by activation of the target membrane receptor (e.g., olfactory receptor) can be measured or detected by any suitable method. For example, an increase in intracellular calcium may be detected by a change in ionic potential in the cell according to some embodiments. In certain embodiments, the change in ionic potential can be detected by fluorescence lifetime imaging microscopy (FLIM) imaging, FRET, or other suitable methods for detection including those disclosed in PCT Publication WO2019200021 and U.S. Patent Application Nos. 2006/0057640, 2008/0081345, 2010/0143337 and 2013/0004983 which are incorporated by reference as if fully set forth herein.

The increase in intracellular calcium allows for a measurable signal of activation by the target membrane receptor (e.g., olfactory receptor) that can be visualized or detected using a suitable reporter. Thus, according to some embodiments, the heterologous host cell or cells described herein is also loaded with a reporter or transfected with a reporter gene capable of transmitting a visual signal or readout in response to an increase in intracellular calcium. There are many suitable reporters that may be used for visualizing changes in intracellular calcium. In some embodiments, the reporter is a Ca²⁺-sensitive dye (e.g., fluo-4 and/or fura-red). When calcium concentration inside the cell is increased upon stimulation of the OR with ligands, the fluo-4 signal increases whereas the fura-red signal decreases, thereby allowing for ratiometric measurements of intracellular calcium concentration. In other embodiments, the reporter is any other suitable fluorescent bioelectricity reporter (FBR). Non-limiting examples of FBRs and methods for their detection may be found in Adame & Levin, General Principles for Measuring Resting Membrane Potential and Ion Concentration Using Fluorescent Bioelectricity Reporters, Cold Spring Harb Protoc. 2012 Apr. 1; 2012(4): 385-397 (10.1101/pdb.top067710) the subject matter of which is incorporated by reference as if fully set forth herein.

Cell signaling events such as intracellular calcium release by neurons are highly dynamic and cause rapid changes in intracellular free calcium. Thus, when certain molecules (e.g., VOCs or other molecules or compounds) are present in the environment (e.g., drug candidates, antagonists, agonists, toxic or hazardous molecules), methods used to detect such molecules using the genetically engineered cells described herein should be capable of detecting such rapid changes in intracellular calcium. In certain embodiments, the reporter used should be sensitive to rapid changes in intracellular calcium and should be able to detect and deliver a visual signal in real time, or within an acceptable timeframe in accordance with the application.

In certain embodiments, the reporter is a genetically encoded calcium indicator (GECI). GECIs are powerful tools useful for imaging of cellular, development, and physiological processes, and are advantageous due to their speed of detecting calcium release and because they need not be loaded into the cells but can be easily transfected to cell lines. GECIs can also be used to measure calcium dynamics in specific subcellular compartments (e.g., endoplasmic reticulum) and can be used in long-term calcium imaging in a non-invasive manner. Examples of GECIs that may be used to transfect the genetically engineered cells in accordance with the embodiments described herein include, but are not limited to, cameleons, FIP-CB_{SM}, Pericams, GCaMPs TN-L15, TNhumTnC, TN-XL, TN-XXL, Twitch's, RCaMP1, jRGECO1a, or any other suitable GECI. In certain embodiments, the GECI used as a reporter gene is a GCaMP gene. In certain embodiments, the GCaMP gene is a GCaMP6m gene (see., e.g., Chen et al., Ultrasensitive fluorescent proteins for imaging neuronal activity, Nature. 2013 Jul. 18; 499(7458):295-300. doi: 10.1038/nature12354, the subject matter of which is incorporated by reference as if fully set forth herein).

Other suitable reporters that can be used in accordance with the embodiments described herein include any suitable fluorophore including, but not limited to, fluorescent proteins (e.g. GFP, YFP, RFP), xanthene derivatives (e.g. fluorescein, rhodamine, Oregon green, eosin, and Texas red), cyanine derivatives (e.g., cyanine, indocarbocyanine, oxacarbocyanine, thiacarbocyanine, and merocyanine), squaraine derivatives and ring-substituted squaraines (e.g., Seta and Square dyes), squaraine rotaxane derivatives (e.g., See Tau dyes), naphthalene derivatives (e.g., dansyl and prodan derivatives), coumarin derivatives, oxadiazole derivatives (e.g., pyridyloxazole, nitrobenzoxadiazole and benzoxadiazole), anthracene derivatives (e.g., anthraquinones, including DRAQ5, DRAQ7 and CyTRAK Orange), pyrene derivatives (e.g., cascade blue, etc.), oxazine derivatives (e.g., Nile red, Nile blue, cresyl violet, oxazine 170, etc.), acridine derivatives (e.g., proflavin, acridine orange, acridine yellow, etc.), arylmethine derivatives (e.g., auramine, crystal violet, malachite green), tetrapyrrole derivatives (e.g., porphin, phthalocyanine, bilirubin), and dipyrromethene derivatives (e.g., BODIPY, aza-BODIPY). Additional reporters that can be used in accordance with the embodiments described herein can be found in PCT Publication WO2019200021, which is incorporated by reference as if fully set forth herein.

According to the embodiments herein, the set of olfactory signaling pathway genes expressed by the genetically engineered cells described herein include a G15 protein chimera (G15olf47), REEP1, REEP2, RTP1s, Ric8b, and Gcamp6m. Thus, in some embodiments, the engineered cell or cells described herein are a heterologous host cell or cells that express G15olf47, REEP1, REEP2, RTP1s, Ric8b, and Gcamp6m. Thus, in some embodiments, the engineered cell or cells described herein are produced by transfecting a heterologous host cell transfected with a set of one or more olfactory signaling pathway genes so that the heterologous host cell is capable of expressing G15olf47, REEP1, REEP2, RTP1s, Ric8b, and Gcamp6m. In one embodiment, the engineered cell is a HEK293T cell transfected with G15olf47, REEP1, REEP2, RTP1s, Ric8b, and Gcamp6m genes. In another embodiment, the engineered cell is an A549 cell transfected with G15olf47, REEP1, REEP2, RTP1s, Ric8b, and Gcamp6m. In another embodiment, the engineered cell is an astrocyte transfected with G15olf47, REEP1, REEP2, RTP1s, Ric8b, and Gcamp6m. In another embodiment, the engineered cell is a Hana3a cell (which already expresses REEP1) transfected with G15olf47, REEP2, RTP1s, Ric8b, and Gcamp6m.

Target Membrane Receptors. The engineered cells described above may be used to express any known target receptor. In certain embodiments, the target membrane receptor is an odorant receptor (OR). The ORs expressed in the engineered cells described herein may be derived from a human genome or a mouse genome. Alternatively, synthetic ORs with sequences that are not found in nature may be used. Such synthetic constructs are still considered ORs based on their sequence and functional similarities to natural ORs.

Although the number of available OR sequences is increasing along genomic data, most of them remain “orphans”, meaning they do not have any known ligand. Thus, according to some embodiments, the genetically engineered cells described herein may be used in methods for deorphanization of receptors and methods of high throughput or rapid compound screening. In some embodiments, methods for deorphanizing an OR may include a step of measuring or otherwise detecting its activity (via a signal, e.g., a reporter) in presence of different compounds (e.g., VOCs) in aerosol samples to find its ligand(s). Since there is a significant number of possible ligands and combinations of ligands, deorphanization is generally partial. According to certain embodiments, the methods for deorphanizing an OR is centered around a limited number of specific compounds, with the goal to screen a library of ORs to find ORs that respond to those compounds. This requires the workflow to be heavily automated as the number of compounds tested and the number of ORs that are acquired increase on a regular basis.

In other embodiments, the target membrane receptor is a receptor identified as associated with a disease, condition, or otherwise identified for drug discovery. Such receptors may be derived from a human genome or from a mammalian genome for use in drug discovery in clinical or veterinary settings. The target membrane receptor may be expressed in cells that are genetically engineered to express signaling pathway molecules that are unique to the target membrane receptor according to some embodiments. In other embodiments, the olfactory signaling pathway molecules and/or reporters discussed above may be utilized to express the target membrane receptor or portion thereof. For example, in some embodiments, a chimeric receptor may be designed such that the intracellular portion corresponds to an olfactory receptor that is expressed by and operates via the olfactory accessory molecules and reporters described above and the extracellular portion corresponds with a ligand binding domain that corresponds with a different target receptor.

In some embodiments, the screening methods employ multiwell plates and plate readers to screen membrane receptor libraries (e.g., OR libraries) in a high throughput way in accordance with the embodiments described above. In certain aspects, each plate has 96 or 384 individual wells, each of which represent one experiment. The screening methods may use a SpectraMax instrument or the Flex3 (Molecular Devices) in accordance with some embodiments. The SpectraMax instrument reports the activation of the ACIII pathway using a cAMP activated luminescent reporter, which is the most sensitive assay but requires a long incubation time, e.g., five hours. The FLex3 uses calcium imaging, which allows for following the activation of both calcium release pathways and for determining the kinetic parameters of that release.

Producing Engineered Cells. To produce the engineered cell or cells described above, the heterologous host cell cells—e.g., a population of heterologous host cells—may be seeded on a culture plate, a well, or other suitable culturing substrate such as the microfluidic biochip discussed in detail below. Next, the set of one or more olfactory signaling pathway genes are delivered to the cells by any suitable method of transfection. For example, Hana3A cells can be modified easily in a short period of time using circular DNA molecules called plasmids, which when combined with cationic lipids like lipofectamine are absorbed by the cells. Astrocytes, on the other hand, are harder to modify and require the use of non-infectious viral vectors.

Thus, in some embodiments, each of the one or more olfactory signaling pathway genes are packaged into one or more expression cassettes that may be inserted into a delivery vehicle. In certain embodiments, the delivery vehicle is a plasmid, but other embodiments may utilize viral vectors (e.g., adenoviral vectors, MVA vectors, lentiviral vectors, AAV vectors, and modified versions thereof), virus like particles (VLPs), or any other suitable vector. The vector or vectors containing the expression cassette(s) are then delivered to the cells. In certain embodiments, plasmids are combined with a transfection agent (e.g., lipofectamine) to facilitate delivery to the cells. In other embodiments, electroporation is used to deliver plasmids to the cells. In other embodiments, a lentiviral vector is used to deliver the genes to the engineered cells.

The transfection may result in transient or permanent expression of the one or more olfactory signaling pathway genes. The permanence of genetic modifications depends on the method used and whether or not the cells are dividing. With lipofection, the plasmid DNA is not integrated in the cell's genome and cannot replicate. During cell division, the plasmids will gradually be diluted and eventually the gene will be lost. When using lentiviral delivery, on the other hand, the DNA is permanently integrated in the cell's genome and thus will be expressed in the cell throughout its lifespan without additional intervention. A cell that has been modified by viral methods can be amplified to create genetically identical copies that all express the gene of interest.

Methods of Rapidly Screening Candidate Molecules or Compounds

In certain embodiments, methods for rapid screening of candidate molecules or compounds are provided. In some embodiments, such methods include providing a microplate, where the microplate includes a microplate body with a plurality of wells arranged in rows and columns and a perimeter flange having an outer sidewall spaced apart from an inner sidewall, a semi-permeable layer on a bottom of the microplate body, a gas space adapted to allow gas to diffuse through the semi-permeable layer, and an optically transparent layer over the gas space. In some embodiments, the gas space of the microplate includes a single continuous gas channel extending under the all the wells. In other embodiments, the gas space of the microplate includes two or more gas channels, each extending under a subset of all the wells. In other embodiments, the gas space of the microplate includes a plurality of gas channels, each of which extends under a single well. In certain embodiments, the wells in the first and last rows and columns are formed in part by the inner sidewalls.

The rapid screening methods may also include a step of adding a population genetically modified cells to each well of the microplate, wherein each population (i) expresses a target membrane receptor and (ii) is capable of emitting a signal upon activation of the target membrane receptor. In certain embodiments, the candidate target membrane receptor expressed by the population of genetically modified cells is different in each well. In other embodiments, the target membrane receptor expressed by the population of genetically modified cells is the same in each well or a subset of wells.

The rapid screening methods may also include a step of injecting a first aerosol sample containing a first candidate molecule or compound (e.g., a VOC or candidate therapeutic molecule or compound) into the gas space of the microplate to deliver the first aerosol sample to one or more wells of the microplate. In certain embodiments, the first candidate molecule or compound (e.g., a VOC or candidate therapeutic molecule or compound) is delivered to each well of the microplate to test the first candidate with a plurality of target membrane receptors. In such embodiments, target receptors may be identified for a particular VOC or other candidate molecule or compound. In other embodiments, the first candidate is delivered to one well or a subset of wells of the microplate in order to test additional candidate molecules or compounds on the same target membrane receptor. In such embodiments, several drug candidates may be screened at the same time in a high throughput manner.

The rapid screening methods may also include a step of detecting any signal emitted from the genetically modified cells contained in each of the wells after injection of the first aerosol sample. The signal may be emitted by a reporter or any other suitable signal discussed above according to certain embodiments.

The rapid screening methods may also include a step of identifying candidate target membrane receptor(s) that are activated by the first candidate molecule or compound.

In certain embodiments, the rapid screening methods may be used to screen one candidate molecule at a time against a plurality of target membrane receptors. In that case, the rapid screening methods may also include steps of purging the gas space with an inert gas, injecting a second aerosol sample containing a second candidate molecule or compound into the gas space of the microplate to deliver the second aerosol sample to each well of the microplate; detecting any signal emitted from the genetically modified cells contained in each of the wells after injection of the second aerosol sample; and identifying candidate target membrane receptors that are responsive to the second candidate molecule or compound using a computer to analyze and record the location [and/or] parameters of any signal emitted from the genetically modified cells. Additional embodiments include repeating the purging, injecting, exposing and identifying steps for each of a plurality of aerosol samples, each of which contain a subsequent candidate molecule or compound for identifying candidate target membrane receptors that are responsive to the subsequent candidate molecules or compounds.

In some embodiments, the candidate target membrane receptor used in the methods described herein is a candidate odorant receptor (OR) and the candidate molecules or compounds are VOCs. In other embodiments, the candidate target membrane receptor used in the methods described herein is a receptor identified as associated with a disease, condition, or otherwise identified for drug discovery and the candidate molecules or compounds are candidate agonists or antagonists of the receptor that may be used as potential therapeutic agents.

Other embodiments of the rapid screening method include adding the genetically modified cells to the microplate in an automated assay system, adding the genetically modified cells to the wells after loading the microplate into the automated assay system, and/or using a computer to analyze and record location parameters of any signal emitted from the genetically modified cells as discussed in the embodiments described herein. In some embodiments, the parameters are recorded and stored in the cloud, as discussed herein.

Briefly stated, a method for rapid screening of candidate molecule or compounds includes providing a microplate having a microplate body including a plurality of wells arranged in rows and columns and a perimeter flange having an outer sidewall spaced apart from an inner sidewall, a semi-permeable layer on a bottom of the microplate body, a gas space adapted to allow gas to diffuse through the semi-permeable layer, and an optically transparent layer over the gas space; adding a population genetically modified cells to each well of the microplate, wherein each population (i) expresses a target membrane receptor and (ii) is capable of emitting a signal upon activation of the target membrane receptor; injecting a first aerosol sample containing a first candidate molecule or compound into the gas space of the microplate to deliver the first aerosol sample to each well of the microplate; detecting any signal emitted from the genetically modified cells contained in each of the wells after injection of the first aerosol sample; and identifying candidate odorant receptors that are activated by the first candidate molecule or compound.

In variations of this method: the gas space of the microplate may include a single continuous gas channel extending under the all the wells, or the gas space of the microplate may include two or more gas channels, each extending under a subset of all the wells. This method may further include injecting one or more additional aerosol samples containing one or more additional candidate molecules or compounds into the gas channels of microplate to deliver the one or more additional aerosol samples to the wells of the microplate; detecting any signal emitted from the genetically modified cells contained in each of the wells after injection of the one or more additional aerosol samples; and identifying target membrane receptors that are activated by the one or more additional candidate molecules or compounds.

Additional steps may include purging the gas space with an inert gas; injecting a second aerosol sample containing a second candidate molecule or compound into the gas space of the microplate to deliver the second aerosol sample to each well of the microplate; detecting any signal emitted from the genetically modified cells contained in each of the wells after injection of the second aerosol sample; and identifying candidate odorant receptors that are responsive to the second candidate molecule or compound using a computer to analyze and record the location parameters of any signal emitted from the genetically modified cells.

The purging, injecting, exposing and identifying steps may be repeated for each of a plurality of aerosol samples each of which contain a subsequent candidate molecule or compound for identifying candidate odorant receptors that are responsive to the subsequent candidate molecule or compound.

The genetically modified cells may be added to the microplate in an automated assay system, before or after loading the microplate into the automated assay system. The wells in the first and last rows and columns may be formed in part by the inner sidewalls. The target receptor expressed by the population of genetically modified cells may be the same or different in two or more of the wells. A computer may be used to analyze and record location parameters of any signal emitted from the genetically modified cells. The candidate molecules or compounds may be candidate drug compounds that are agonists or antagonists of the target membrane receptors. The target membrane receptors may be odorant receptors. The candidate molecules or compounds may be VOCs.

Another method for rapid screening of candidate molecule or compound includes providing a microplate having a microplate body including a plurality of wells arranged in rows and columns, a semi-permeable layer on a bottom of the microplate body, a gas space adapted to allow gas to diffuse through the semi-permeable layer. A population genetically modified cells is added to each well of the microplate, wherein each population (i) expresses a target membrane receptor and (ii) is capable of emitting a signal upon activation of the target membrane receptor, the cells on the membrane. A first aerosol sample containing a first candidate molecule or compound is injected into the gas space of the microplate to deliver the first aerosol sample to one or more of the wells of the microplate. Any signal emitted from the genetically modified cells contained in each of the wells after injection of the first aerosol sample is detected. Candidate odorant receptors that are activated by the first candidate molecule or compound are identified. The genetically engineered cells may be generated from heterologous host cells that are transfected with one or more genes, at least partially from olfactory neurons, and/or the cells may bey wild type or engineered cell type that are capable of expressing an olfactory or odorant receptor (OR). The cells may be genetically modified to express the set of accessory proteins to facilitate expression of the OR and visualization of its activation; and/or to express factors that increase cell durability, ability to divide and proliferate, or other characteristics to enhance survival when used in the system. The cells may be neuronal or glial cells and derivatives thereof (e.g., olfactory neurons, astrocytes), embryonic cells and derivatives thereof (e.g., HEK293T cells, HANA3A cells), endothelial cells and derivatives thereof (e.g., A549 cells), or stem cells. The host cell may be a HEK293T cell, HANA3A cell, primary astrocyte, or an A549 cell.

The cells may be engineered to express sufficient signaling molecules to activate the calcium signaling pathway including one or more of: a suitable G protein or portion thereof that is activated upon a candidate molecule's binding of a target G protein coupled membrane receptor (i.e., the target membrane receptor) and subsequent activation of the phospholipase C (PLC) pathway to release intracellular calcium, and suitable accessory proteins to facilitate expression of the target membrane receptor. The cells may be loaded with a reporter or transfected with a reporter gene capable of transmitting a visual signal or readout in response to an increase in intracellular calcium. When operating with multiple different gas samples, the first sample may be purged before providing second and subsequent gas samples, and performing the steps described above.

Thus systems, devices and methods have been shown and described. Various changes and substitutions may of course be made without departing from the spirit and scope of the invention. The invention, therefore, should not be limited, except by the following claims and their equivalents. Application Nos. 63/189,015; Ser. Nos. 17/153,747; 16/486,132; 16/344,791; 17/251,557 and 17/571,363 are incorporated herein by reference.

1. A microplate comprising:
a microplate body having a plurality of wells arranged in rows and columns, the microplate body including a perimeter flange having an outer sidewall spaced apart from an inner sidewall;
a semi-permeable layer on a bottom of the microplate body;
a fluid space adapted to allow a fluid to diffuse through the semi-permeable layer; and
an optically transparent layer over the fluid space.

2. The microplate of claim 1 with the fluid space comprising a channel extending from a first side of the microplate body to a second side of the microplate body.

3. The microplate of claim 1 wherein the fluid space comprises two or more parallel segments.

4. The microplate of claim 3 having 96, 384 or 1536 wells.

5. The microplate of claim 4 comprising four parallel segments, an inlet at a first end of the first segment and an outlet at a second end of the fourth segment.

6. The microplate of claim 1 wherein the wells form a rectangular array encompassing substantially the entire surface of the microplate body.

7. The microplate of claim 3 wherein each segment extends under at least two rows of wells, and wherein the wells in the first and last rows and columns are formed in part by the inner sidewalls.

8. The microplate of claim 1 wherein the microplate body, the semi-permeable layer and the optically transparent layer are sealed to prevent escape of gas or liquid from the gas space or the wells.

9. The microplate of claim 8 further including an adhesive layer adhering the semi-permeable layer to the microplate body, the adhesive layer comprising an adhesive substance applied to the bottom surface of the microplate body.

10. The microplate of claim 1 wherein each well has an open bottom end closed off by the semi-permeable layer.

11. A microplate comprising:
a microplate body having a plurality of wells, each well having an open top;
the bottom of each well closed off by a bottom layered assembly including:
a semi-permeable layer adhered onto a bottom surface of the microplate body by an adhesive layer;
a fluid space adapted to allow fluid to diffuse through the semi-permeable layer; and
an optically transparent non-permeable layer over the perfusion layer.

12. The microplate of claim 11 wherein the semi-permeable layer comprises a membrane which is gas permeable and liquid impermeable, and wherein the membrane is adhered to the bottom surface of the microplate body by an adhesive layer.

13. The microplate of claim 11 wherein the fluid space is provided in a perfusion layer adhered to the semi-permeable layer, wherein the semi-permeable layer is transparent and impermeable to liquid.

14. The microplate of claim 11 having 96, 384 or 1536 wells.

15. The microplate of claim 14 comprising four parallel segments, an inlet at a first end of the first segment and an outlet at a second end of the fourth segment.

16. The microplate of claim 14 wherein the wells form a rectangular array encompassing substantially the entire surface of the microplate body.

17. The microplate of claim 14 wherein each segment extends under at least two rows of wells, and wherein the wells in the first and last rows and columns are formed in part by the inner sidewalls.

18. An assay for characterizing a plurality of odorant receptors comprising:
a microplate having a plurality of wells;
a semipermeable membrane forming a bottom of each of the wells;
a plurality of genetically modified cells attached to the membrane in each well;
all of the genetically modified cells in each well expressing the same odorant receptor and capable of generating an optically detectable signal when the odorant receptor binds a volatile organic compound;
a single continuous gas channel extending under the all the wells;
the single continuous gas channel having a width extending under at least two rows of the wells;
an inlet for introducing a volatile organic compound laden gas into the gas channel;
an outlet for receiving the volatile organic compound laden gas after the gas has passed through the channel;
the single continuous gas channel between the membrane and an optically transparent bottom layer; and
an optical detection system adapted to detect an optical signal emitted by one or more of the cells.
